(19) United States
(12) Patent Application Publication
(10) Pub. No.: US 2020/0151661 A1
(43) Pub. Date: May 14, 2020

(54) DECENTRALIZED CARGO MARKETPLACE AND DELIVERY

(71) Applicant: Ford Global Technologies, LLC, Dearborn, MI (US)

(72) Inventor: Abraham MEZAAEL, Southfield, MI (US)

(21) Appl. No.: 16/185,807

(22) Filed: Nov. 9, 2018

(51) Int. Cl. G06Q 10/08; G05D 1/02; G05D 1/00

(52) U.S. Cl. CPC G06Q 10/0836; G06Q 10/0833; G05D 2201/0213; G05D 1/0022; G05D 1/0212

(57) ABSTRACT

A vehicle includes a controller. The controller is configured to receive a transaction defining an order for a predetermined unit of cargo space of the vehicle and being recorded in a blockchain containing a ledger describing availability of the cargo space and validated by nodes of a decentralized peer network such that the blockchain is common to the nodes. The controller is further configured to execute commands to travel to a pickup location upon confirmation of the transaction to the decentralized peer network.

### TECHNICAL FIELD

This disclosure relates to decentralized cargo delivery and markets thereof.

### BACKGROUND

Transportation systems require a central repository and central orchestration to operate. For example, a taxi service may receive a pickup request from a central server or server cluster configured to organize transportation. Central authorities may require undesirable maintenance and upkeep that original equipment manufacturers and other transportation providers avoid.

### SUMMARY

A vehicle includes a controller. The controller is configured to receive a transaction defining an order for a predetermined unit of cargo space of the vehicle and being recorded in a blockchain, containing a ledger describing availability of the cargo space, validated by nodes of a decentralized peer network such that the blockchain is common to the nodes. The controller is further configured to execute commands to travel to a pickup location upon confirmation of the transaction to the decentralized peer network.

A vehicle includes a controller configured to receive a transaction defining an order for a predetermined unit of cargo space of the vehicle and being recorded in a blockchain, containing a ledger describing availability of the cargo space, validated by nodes of a decentralized peer network such that the blockchain is common to the nodes. The controller is further configured to reserve the cargo space for goods related to the order upon confirmation of the transaction to the decentralized peer network.

A method by a controller includes receiving a transaction defining an order for a predetermined unit of cargo space of a vehicle and being recorded in a blockchain, containing a ledger describing availability of the cargo space, validated by nodes of a decentralized peer network such that the blockchain is common to the nodes. The method further includes executing commands to travel to a pickup location upon confirmation of the transaction to the decentralized peer network.

### BRIEF DESCRIPTION OF THE DRAWINGS

FIG. 1 is a schematic overview of a vehicle;

FIG. 2 is a map including a vehicle route with a pickup location and a destination;

FIG. 3 is a perspective view of a vehicle cargo hold and associated predetermined units of cargo space;

FIG. 4 is a schematic diagram of a blockchain including a ledger of transactions; and

FIG. 5 is an algorithm for performing portion of this disclosure.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Decentralized transactions through blockchain technology enables vehicle cargo holds to be made available for sale without management and upkeep by a central authority. Indeed, an online marketplace for transactions provides users with the ability to purchase cargo space of vehicles already en route. For example, an autonomous vehicle may be taxiing passengers from one location to the next and driving near a cargo pickup location. The vehicle's route may also traverse past a delivery location for the cargo. Such route information may be made available to an online marketplace along with cargo hold availability information to enable users to bid on the available cargo hold space. Accepted bids may be sent to a decentralized transaction register operating on vehicles subscribed to the service. When a vehicle recognizes that its cargo space has been purchased, the vehicle may update itinerary and route information in accordance with the transaction. Without requiring a central authority, vehicles may transact to loan out predetermined units of cargo.

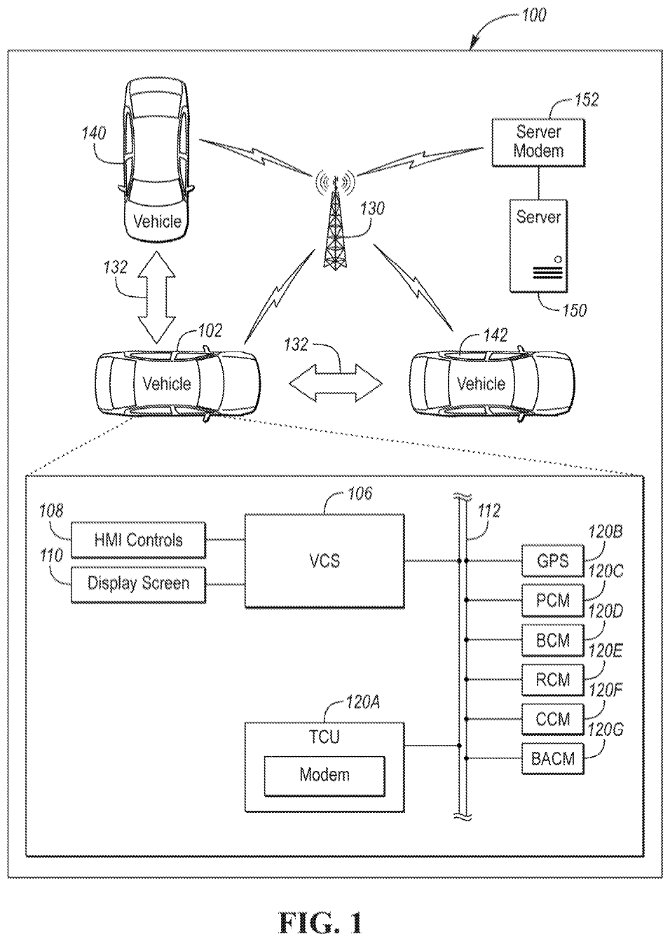

FIG. 1 illustrates an example system 100 including a vehicle 102. The vehicle 102 may include a vehicle computing system (VCS) 106 configured to communicate over a wide-area network using a telematics control unit (TCU) 120A. The TCU 120A may have various modems 122 configured to communicate over respective communications paths and protocols. For example, the TCU 120A may include a PAN modem and a 4G modem. While an example system 100 is shown in FIG. 1, the example components as illustrated are not intended to be limiting. Indeed, the system 100 may have more or fewer components, and additional or alternative components and/or implementations may be used.

The vehicle 102 may include various types of automobile, crossover utility vehicle (CUV), sport utility vehicle (SUV), truck, recreational vehicle (RV), boat, plane, drone, or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The VCS 106 may be configured to support voice command and BLUETOOTH interfaces with the driver and driver carry-on devices, receive user input via various buttons or other controls, and provide vehicle status information to a driver or other vehicle 102 occupants. An example VCS 106 may be the SYNC® system provided by FORD MOTOR COMPANY of Dearborn, Mich.

The VCS 106 may further include various types of computing apparatus in support of performance of the functions of the VCS 106 described herein. In an example, the VCS 106 may include one or more processors configured to execute computer instructions, and a storage medium on which the computer-executable instructions and/or data may be maintained. A computer-readable storage medium (also referred to as a processor-readable medium or storage) includes any non-transitory (e.g., tangible) medium that participates in providing data (e.g., instructions) that may be read by a computer (e.g., by the processor(s)). In general, a processor receives instructions and/or data, e.g., from the storage, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, PL/SQL, etc.

The VCS 106 may be configured to communicate with TCU 120A. The TCU 120A may include a plurality of modems 122 capable of packet-switch or circuit-switched signaling. The TCU 120A may control the operation of the modems 122 such that a suitable communication path is used. The modems may be configured to communicate over a variety of communications paths 130. The paths may be configured with circuit-switched, packet-switched, signaling, or combination thereof. Packet-switched communication paths may be Internet Protocol (IP)-based or use packet-based switching to transfer information. For example, the packet-switched communication may be long-term evolution (LTE) communications. In some circumstances the circuit-switched communication path may be SIGTRAN or another implement, carrying circuit-switched signaling information over IP. The underlying signaling information is, however, still formatted under the circuit-switched protocol.

The VCS 106 may also receive input from human-machine interface (HMI) controls 108 configured to provide for occupant interaction with the vehicle 102. For instance, the VCS 106 may interface with one or more buttons or other HMI controls 108 configured to invoke functions on the VCS 106 (e.g., steering wheel audio buttons, a push-to-talk button, instrument panel controls, etc.). The VCS 106 may also drive or otherwise communicate with one or more displays 110 configured to provide visual output to vehicle occupants, e.g., by way of a video controller. In some cases, the display 110 may be a touch screen further configured to receive user touch input via the video controller, while in other cases the display 110 may be a display only, without touch input capabilities. In an example, the display 110 may be a head unit display included in a center console area of the vehicle 102 cabin. In another example, the display 110 may be a screen of a gauge cluster of the vehicle 102.

The VCS 106 may be further configured to communicate with other components of the vehicle 102 via one or more in-vehicle networks 112 or vehicle buses 112. The in-vehicle networks 112 may include one or more of a vehicle controller area network (CAN), an Ethernet network, and a media oriented system transfer (MOST), as some examples. The in-vehicle networks 112 may allow the VCS 106 to communicate with other vehicle 102 systems, such as a vehicle modem of the TCU 120A (which may not be present in some configurations), a global positioning system (GPS) module 120B configured to provide current vehicle 102 location and heading information, and various other vehicle ECUs configured to cooperate with the VCS 106. As some non-limiting possibilities, the vehicle ECUs may include a powertrain control module (PCM) 120C configured to provide control of engine operating components (e.g., idle control components, fuel delivery components, emissions control components, etc.) and monitoring of engine operating components (e.g., status of engine diagnostic codes); a body control module (BCM) 120D configured to manage various power control functions such as exterior lighting, interior lighting, keyless entry, vehicle door locking and unlocking, remote start, and point of access status verification (e.g., closure status of the hood, doors and/or trunk of the vehicle 102); a radio transceiver module (RCM) 120E configured to communicate with key fobs or other local vehicle 102 devices including mobile phones and nomadic devices; a climate control management (CCM) 120F module configured to provide control and monitoring of heating and cooling system components (e.g., compressor clutch and blower fan control, temperature sensor information, etc.); and a battery control module (BACM) 120G configured to monitor the state of charge or other parameters of the battery of the vehicle 102.

In an example, the VCS 106 may be configured to access the communications features of the TCU 120A by communicating with the TCU 120A over a vehicle bus 112. As some examples, the vehicle bus 112 may include a controller area network (CAN) bus, an Ethernet bus, or a MOST bus. In other examples, the VCS 106 may communicate with the server 150 via a server modem 152 using the communications services of the modems 122. The server 150 may include a datastore or database repository including access keys and pre-shared symmetric keys for all of the manufactures vehicles. The server 150 may include multiple access keys and symmetric keys for vehicle 102. The server 150 may associate one access key with a plurality of pre-shared symmetric keys via key identifiers. The key identifiers may be defined by manufacturer makes and models. The server 150 may receive the access keys or pre-shared keys from the vehicle 102 during manufacture or designate access keys and symmetric keys during manufacture or during use of the vehicle 102.

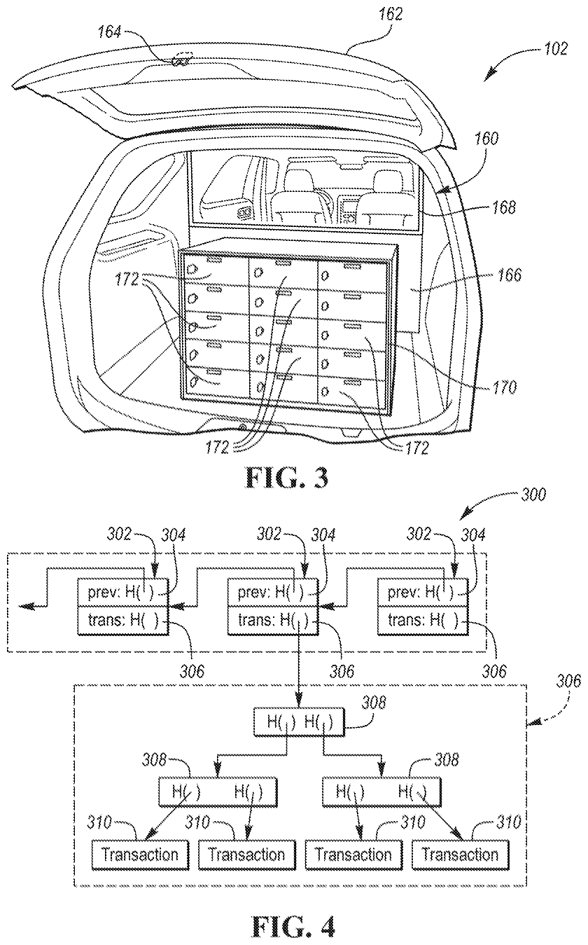

The system 100 includes additional vehicles 140, 142. The additional vehicles 140, 142 provide a decentralized network 132 of nodes for validating a blockchain of transactions as shown in FIG. 4. The decentralized network may operate over any communications protocol. For example, the decentralized network may operate over a V2V or cellular network 130. Although the list of transactions including cargo locations may reside on the vehicles 102, 140, 142, the online marketplace may reside on the server 150. The server 150 may provide accessible web information to users attempting to create a transaction similar to a financial stock market where vehicle cargo space along routes are exchanged similar to stocks.

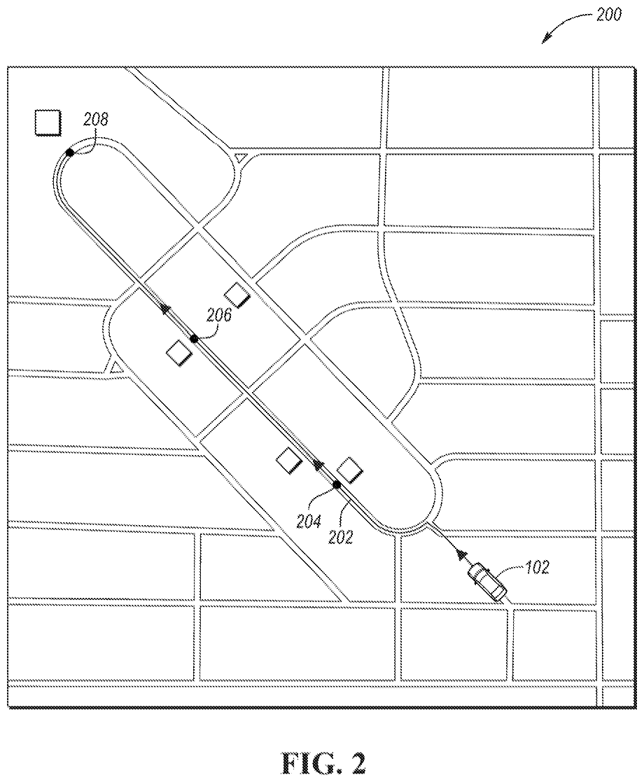

Referring to FIG. 2, a map 200 is shown. The map 200 includes a vehicle 102. The vehicle is traveling along pre-existing route 202. The vehicle 102 is traveling to destination 208 along the route 202. During transit, the vehicle 102 receives indication of a transaction on the blockchain. The transaction includes a pickup location 204 and a delivery location 206. Although shown along the route 202, pickup location 204 and deliver location 206 may be located near or generally nearby the route 202. In such circumstances, the vehicle 102 may navigate a different route to accommodate the delivery of goods.

As shown in FIG. 3, the vehicle 102 may include a cargo hold 160. The cargo hold 160 may be on any location of the vehicle 102. The cargo hold 160 may be in the front, rear, above, or underneath with respect to the vehicle chassis. The cargo hold 160 may further be dislocated from the vehicle 102 and towed. As shown, the cargo hold 160 includes a hatch 162, with included locking latch 162. The locking latch 162 is controlled by a vehicle controller (e.g., VCS 106). The vehicle 102 may include a passenger compartment in addition to the cargo hold 160. The passenger compartment may be separated from the cargo hold 160 through transparent glass 168 and walls 166 to prevent access from passengers also being transported by the vehicle 102. The cargo hold 160 may include individual predetermined cargo units 172 as part of a larger cargo space 170. The predetermined unit 172 may be equivalent to a unit of measure of the block such that one unit of value in the blockchain is equal to a predetermined unit 172 of cargo space 170. It should be appreciated that any arrangement of cargo space may be used and designations of cargo holds, cargo space, and predetermined units may be loosely defined as an entire trunk or cargo area of a vehicle.

Referring to FIG. 4, a block chain 300 is shown. The blockchain 300 includes a tamper resistant ledger of signed blocks 302. Each block 302 is signed with a hash 304 from the previous block and a data repository of previous transactions 306. The transactions 306 may be stored in a Merkle tree, as known in the art. The transactions may be stored in a hashed 308 organization of transactions 310 comprising the transaction ledger. The transactions 310 may include information relating to available cargo space as an account. The transactions 310 may include information relating to the history of cargo space 170 and its relationship to transactions 310 from the market that enables bidding on cargo space 170.

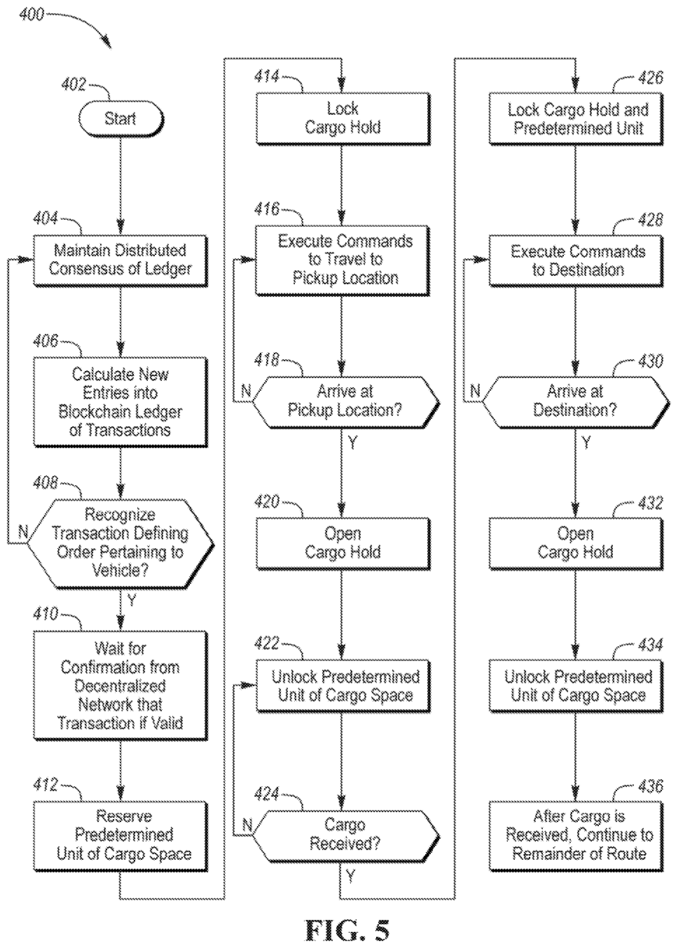

FIG. 5 includes an algorithm 400 for implementing portions of this disclosure. The algorithm 400 beings in step 402. In step 404, the controller maintains the distributed consensus of the ledger within the blockchain 300. That is, the vehicles 102, 140, 142 and other nodes constantly validate the common blockchain 300 by ensuring the hashed transactions 310 are valid. In step 406 the vehicles 102, 140, 142 and other nodes calculate new entries into the blockchain 300 ledger of transactions 310. That is, similar to blockchain 300 implementations for Bitcoin and other cryptocurrencies, blocks 302 are approved by a random one of the nodes 102, 140, 142 when a sufficiently difficult algorithm is used to find answers to a puzzle via mining.

In step 408, the vehicle 102 may recognize that a transaction defining an order related to its vehicle through digital signatures is stored within the blockchain 300. Upon recognition, the vehicle 102 waits for confirmation of the transaction 210 from the decentralized network that the transaction 210 is valid. This validation may require waiting for a sufficient number of additional blocks 302 to be added such that the transaction 210 corresponding to the vehicle 102 is within the valid chain of blocks 302 after a fork. In step 412, the vehicle 102 reserves a predetermined unit 172 of cargo space 170. The reservation may lock the predetermined unit 172. The vehicle 102 may lock the cargo hold 160 in step 414 to ensure the predetermined unit 172 is not accessed. In step 416, the vehicle 102 may execute commands to travel to the pickup location 204. The autonomous vehicle commands may include retrieving information from the GPS receiver 120B and other vehicle systems. The commands are executed until the vehicle 102 determines it has arrived at the pickup location 204 in step 418. At the pickup location 204 the vehicle 102 opens the cargo hold 160 in step 420. In step 422, the vehicle 102 unlocks the predetermined unit 172 of cargo space 170. After receiving the cargo in step 424, the vehicle 102 locks the cargo hold 160 and the predetermined unit 172. The vehicle 102 then executes commands in step 428 to reach the delivery location 206. After arriving at the delivery location 206 in step 430 the vehicle opens the cargo hold 160 in step 432 and the predetermine unit 172 in step 424. After the cargo is retrieved in step 436, the vehicle 102 continues to the destination 208.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a controller configured to
receive a transaction defining an order for a predetermined unit of cargo space of the vehicle and being recorded in a blockchain containing a ledger describing availability of the cargo space and validated by nodes of a decentralized peer network such that the blockchain is common to the nodes, and
execute commands to travel to a pickup location upon confirmation of the transaction to the decentralized peer network.

2. The vehicle of claim 1, wherein the controller is further configured to reserve the cargo space for goods related to the order upon confirmation of the transaction to the decentralized peer network.

3. The vehicle of claim 2, wherein the reservation includes locking a cargo hold associated with the predetermined unit unless the vehicle is located at the pickup location or a delivery location.

4. The vehicle of claim 2, wherein the reservation includes locking the predetermined unit unless the vehicle is located at the pickup location or a delivery location.

5. The vehicle of claim 1, wherein the pickup location is along a pre-existing route of the vehicle.

6. The vehicle of claim 1, wherein a delivery location is along a pre-existing route of the vehicle.

7. The vehicle of claim 1, wherein at least one of the nodes is the vehicle.

8. The vehicle of claim 1, wherein at least one of the nodes is another vehicle.

9. A vehicle comprising:
a controller configured to
receive a transaction defining an order for a predetermined unit of cargo space of the vehicle and being recorded in a blockchain containing a ledger describing availability of the cargo space and validated by nodes of a decentralized peer network such that the blockchain is common to the nodes, and
reserve the cargo space for goods related to the order upon confirmation of the transaction to the decentralized peer network.

10. The vehicle of claim 9, wherein the controller is further configured to reserve the cargo space for goods related to the order upon confirmation of the transaction to the decentralized peer network.

11. The vehicle of claim 10, wherein the reservation includes locking a cargo hold associated with the predetermined unit unless the vehicle is located at a pickup location or delivery location.

12. The vehicle of claim 11, wherein the reservation includes locking the predetermined unit unless the vehicle is located at the pickup location or a delivery location.

13. The vehicle of claim 12, wherein the pickup location is along a pre-existing route of the vehicle.

14. The vehicle of claim 12, wherein the delivery location is along a pre-existing route of the vehicle.

15. The vehicle of claim 9, wherein at least one of the nodes is the vehicle.

16. The vehicle of claim 9, wherein at least one of the nodes is another vehicle.

17. A method comprising:
executing by a controller commands to travel to a pickup location upon confirmation of a transaction to a decentralized peer network, the transaction defining an order for a predetermined unit of cargo space of a vehicle and being recorded in a blockchain containing a ledger describing availability of the cargo space and validated by nodes of a decentralized peer network such that the blockchain is common to the nodes.

18. The method of claim 17 further comprising reserving the cargo space for goods related to the order upon confirmation of the transaction to the decentralized peer network.

19. The method of claim 18, wherein the reserving includes locking a cargo hold associated with the predetermined unit unless the vehicle is located at the pickup location or delivery location.

20. The method of claim 18, wherein the reserving includes locking the predetermined unit unless the vehicle is located at the pickup location or delivery location.
